(19) United States
(12) Patent Application Publication
(10) Pub. No.: US 2020/0050734 A1
(43) Pub. Date: Feb. 13, 2020

(54) APPARATUSES HAVING DIVERSIFIED LOGIC CIRCUITS AND METHODS THEREOF

(71) Applicant: NXP B.V., Eindhoven (NL)

(72) Inventor: Jan-Peter Schat, Hamburg (DE)

(21) Appl. No.: 16/057,106

(22) Filed: Aug. 7, 2018

(51) Int. Cl. G06F 17/50

(52) U.S. Cl. CPC G06F 17/5081; G06F 17/505

(57) ABSTRACT

An example apparatus includes application circuit that carries out a specific set of actions on an input data vector, and a decoding circuit. The application circuit includes: a first diversification logic circuit that processes data corresponding to the input data vector and in response, generates a coded first output data vector; and a second diversification logic circuit that processes the data corresponding to the input data vector and in response, generate a coded second output data vector, the coded second output data vector being uniquely coded relative to the coded first output data vector. The decoding circuit assesses the coded first output data vector relative to the coded second output data vector and, in response, generates output data indicative of a likelihood of a design weakness in the application circuit.

### OVERVIEW

Aspects of various embodiments are directed to apparatuses having diversified logic circuits used for providing a plurality of coded-diversification pathways.

Many integrated circuits, such as integrated circuits used for safety-sensitive applications, can have difficult to determine design weaknesses. Such design weakness can cause lifetime failure rates beyond acceptable thresholds and other issues, such as timing issues on pathways.

These and other matters have presented challenges to efficiencies of apparatuses having diversified logic circuit implementations, for a variety of applications.

### SUMMARY

Various example embodiments are directed to issues such as those addressed above and/or others which may become apparent from the following disclosure concerning apparatuses that provide a plurality of coded-diversification pathways via different diversification logic circuits.

In certain example embodiments, aspects of the present disclosure involve circuits that have a plurality of coded-diversification pathways provided by different diversification logic circuits. The different diversification logic circuits are redundant and diversified versions of one another that respectively provide the same function in different ways.

In a more specific example embodiment, an apparatus includes an application circuit, and a decoding circuit. The application circuit carries out a specific set of actions on an input data vector. The application circuit includes a plurality of coded-diversification pathways. For example, the plurality of coded-diversification pathways include a first diversification logic circuit and a second diversification logic circuit. The first diversification logic circuit processes data corresponding to the input data vector and in response, generates a coded first output data vector. The second diversification logic circuit processes the data corresponding to the input data vector and in response, generates a coded second output data vector. The coded second output data vector is uniquely coded relative to the coded first output data vector. The decoding circuit, which includes a decoder that is configured as a function of the second diversification logic circuit, assesses the coded first output data vector relative to the coded second output data vector and, in response, generates output data indicative of a likelihood of a design weakness in the application circuit. In various embodiments, the application circuit and other circuitry (e.g., other application circuits and/or an application-specific circuit) are implemented as parts of a common integrated circuit chip with other circuitry and in other embodiments implemented using different chips of an integrated circuit chip. Both the application circuit and the other circuitry can include field-effect circuits manufactured using common materials and manufacturing steps.

The second diversification logic circuit is a diverse and redundant version of the first diversification logic circuit. More specifically, the second diversification logic circuit is not configured and arranged the same as the first diversification logic. For example, the second diversification logic circuit includes negative logic and the first diversification logic circuit includes positive logic. In other aspects and/or in addition, the second diversification logic can include at least one of a complex cell, timing circuitry affecting processing timing of the coded second output data vector, a half or full adder, relatively-low threshold voltage transistors and/or relatively-high threshold voltage transistors, among other variations. The first and second diversification logic circuits can provide the same function and output data vectors that are uniquely coded. As a specific example, the first diversification logic circuit generates the coded first output data vector at a time defined as a function of the first diversification logic circuit, and the second diversification logic circuit generates the coded second output data vector at a time defined as a function of the second diversification logic circuit. The decoding circuit, in such an example, can process the coded first output data vector and the coded second output data vector by aligning the times defined as the functions of the respective first and second diversification logic circuits.

In a number of specific embodiments, the apparatus includes more than two diversification logic circuits. That is, the apparatus can include two or more redundant versions of a logic circuit. The third diversification logic circuit can include a mixture or different combination of logic than the first and second diversification logic circuits. As a specific example, the second diversification logic circuit includes negative logic as compared to positive logic of the first diversification logic circuit and the third diversification logic circuit includes a mixture of the negative logic and positive logic. The third diversification logic processes the received data and in response, generates a coded third output data vector, the coded third output data vector being uniquely coded relative to the coded first output data vector and the coded second output data vector. In various embodiments, each of the diversification logic circuits can be located at different places with respect to one another.

In other specific aspects, the apparatus further includes a comparison circuit. The comparison circuit can be part of the decoding circuit or separate therefrom. The comparison circuit compares the coded first and second output data vectors, and optionally, the coded third output data vector, and generates the output data indicative of the likelihood of the design weakness based on the comparison. The comparison circuit can, for example, generate the output data based on a two-of-three vote between the output data vectors as decoded.

In another specific example embodiment, a method includes carrying out a specific set of actions on an input data vector via an application circuit, and providing the input data vector through a plurality of coded-diversification pathways. For example, the method includes processing received data corresponding to the input data vector through a first coded-diversification pathway provided by a first diversification logic circuit and, in response, providing a coded first output data vector, and processing the received data through a second coded-diversification pathway provided by a second diversification logic circuit and in response, generating a coded second output data vector, the coded second output data vector being uniquely coded relative to the coded first output data vector. The method further includes assessing the coded first output data vector relative to the coded second output data vector, and in response, generating output data indicative of a likelihood of design weakness in the application circuit.

As previously described, the second diversification logic circuit is a redundant and diversified version of the first diversification logic circuit. Generating the coded second output data vector can include generating the coded second output data vector that is a negative version of the coded first output data vector, although embodiments are not so limited. Further, the data can be processed through additional coded-diversification data pathways. In specific embodiments, the method further includes processing the received data through a third coded diversification pathway provided by a third diversification logic circuit and in response, generating a coded third output data vector, the coded third output data vector being uniquely coded relative to the coded first and coded second output data vectors. The coded first output data vector can be assessed relative to the coded second output data vector and the coded third output data vector, and in response, the output data indicative of the likelihood of design weakness in the application specific circuit is generated.

In a number of embodiments, the method further includes (and/or the above-describe apparatus further performs) performing an additional action in response to the assessment of the coded first output data vector relative to the coded second output data vector indicating a likelihood of the weakness. The additional action includes at least one of: performing a built-in self-test, disabling one of the first and second (and/or third) diversification logic circuits, rebooting the system, issuing a warning that the application circuit may be unreliable, and shutting the system down, among other actions.

The above discussion/summary is not intended to describe each embodiment or every implementation of the present disclosure. The figures and detailed description that follow also exemplify various embodiments.

### BRIEF DESCRIPTION OF FIGURES

Various example embodiments may be more completely understood in consideration of the following detailed description in connection with the accompanying drawings, in which:

FIG. 1 illustrates an example of an apparatus having diversification logic circuits, in accordance with various embodiments;

FIGS. 2A-2B illustrate specific examples of apparatuses having diversification logic circuits, in accordance with various embodiments;

FIG. 3 illustrates an example apparatus, in accordance with various embodiments; and

FIG. 4 illustrates an example integrated circuit in accordance with various embodiments.

While various embodiments discussed herein are amenable to modifications and alternative forms, aspects thereof have been shown by way of example in the drawings and will be described in detail. It should be understood, however, that the intention is not to limit the disclosure to the particular embodiments described. On the contrary, the intention is to cover all modifications, equivalents, and alternatives falling within the scope of the disclosure including aspects defined in the claims. In addition, the term “example” as used throughout this application is only by way of illustration, and not limitation.

### DETAILED DESCRIPTION

Aspects of the present disclosure are believed to be applicable to a variety of different types of apparatuses, systems and methods involving apparatuses that provide a plurality of coded-diversification pathways via different diversification logic circuits. In certain implementations, aspects of the present disclosure have been shown to be beneficial when used in the context of application circuits that have different diversification logic circuits that are redundant and diversified versions of one another and that respectively provide the same function in different ways. While not necessarily so limited, various aspects may be appreciated through the following discussion of non-limiting examples which use exemplary contexts.

Accordingly, in the following description various specific details are set forth to describe specific examples presented herein. It should be apparent to one skilled in the art, however, that one or more other examples and/or variations of these examples may be practiced without all the specific details given below. In other instances, well known features have not been described in detail so as not to obscure the description of the examples herein. For ease of illustration, the same reference numerals may be used in different diagrams to refer to the same elements or additional instances of the same element. Also, although aspects and features may in some cases be described in individual figures, it will be appreciated that features from one figure or embodiment can be combined with features of another figure or embodiment even though the combination is not explicitly shown or explicitly described as a combination.

Many circuits, such as those used for safety-sensitive applications, are manufactured in (e.g., small, such as 10 nm) process nodes. The circuits can have reliability weaknesses that cause particular lifetime failure rates and can also have other design weaknesses, such as timing issues on the pathways. Lifetime failure rates and other design weaknesses can be difficult to predict and stimulate. Example safety-sensitive applications can include automobile driver assist systems, medical, military, and aero-space systems, and other data applications. Embodiments in accordance with the present disclosure can identify and/or mitigate design weaknesses in integrated circuits (IC), including lifetime failure rate and other systematic design weakness, by providing a plurality of coded-diversification pathways using diversification logic circuitry that output coded data vectors that are uniquely coded relative to one another. The different diversification logic circuits are diverse redundant versions of one another. More specifically, the diversification logic circuits are redundant (e.g., duplicated or tripled (or more)), with each version being a replica of the other that provides the same function in a different way. In specific examples, the different ways of providing the function can include different combinations of positive logic and negative logic (and mixtures thereof), complex cells and simple cells, timing circuitry affecting timing of the coded output data vectors, and/or relatively-low threshold voltage transistors and relatively-high threshold voltage transistors. Lifetime failure rates (e.g., the parametric change due to aging) can be addresses by the redundant version, e.g., the different diversification logic, being fed the same input signals as the original diversification logic circuit. The output data vectors between the different diversification logic circuits are compared. In the case of a mismatch, an action can occur, such as performing a built-in self-test, disabling the defective diversification logic circuit, rebooting the system, issuing a warning that the application circuit may be unreliable, and/or shutting-down the system. Systematic design weakness is addressed by the replica providing the function in a different way, such that failure of one design is resolved by the other design. If the redundant logic circuit were an exact copy, and not diversified, any weakness may also be copied to the replica(s). The diversification logic circuit provides the different coded-pathways via implementing the intended function in two or more different ways, such that failure of one of the designs can be overcome by implementation of another design.

As noted above, stimulating and predicting the weakness can be difficult due to the size of the processing nodes. In many instances, it is difficult, if not impossible, to predict which of the designs is weaker or stronger. As this is not limited to a few cell types, changing the manner that the logic circuitry provides the function can create the different coded-diversification pathways. In some specific embodiments, the design weakness is overcome by different implementations on the gate level, such as by providing different coded-diversification pathways using different combinations of positive and negative logic. For example, it may be identified that AND gates can be more susceptible to aging than OR gates, or vice versa. In some instances, negative-bias temperature instability (NBTI) can be sensitive for a transistor, such as a p-type metal-oxide semiconductor (PMOS) transistor, with an input of zero, such that the aging susceptibility impacts logic gates in or more of the logic modules and not in another. Additionally, timing issues, such as racing can cause weaknesses due to imprecise timing descriptions in the core library descriptions, or by aging. Another weakness is susceptibility to Single Event Upsets (SEU) such as in configurations of static random-access memory (SRAM) of a field-programmable gate array (FPGA). As a specific example, SEUs can cause or impact 92% of tie-high faults but only 18% of tie-low faults (where high and low are respectively referring to the voltage level irrespective of logic being 0 or 1). One may expect tie-0 and tie-1 to be equally distributed (e.g., 92% and 92% or 18% and 18%); hence it is surprising that it is unequally distributed, namely 18% and 92%. This can result in different vulnerabilities for positive logic as compared to negative logic. For example, a high-active reset tree can be affected by the many tie-high faults, and a low-active reset tree can be affected by the few tie-low faults. In other implementations/in other process nodes, it may be vice versa, however, high-active reset trees may be affected by fewer faults than low-active reset trees. By changing at least some of the logic circuits from positive to negative logic, different coded-diversification pathways are created. Additionally, the different diversification logic circuits can be located at different locations of the application circuit. Even if the negative logic block turns out to have more sensitive pathways or nodes than the positive-logic block, these can be at very different locations than the positive-logic block and can be compensated for by a redundancy voter circuit. Although embodiments are not so limited, the different-coded diversification pathways can be provided via different combinations of simple and complex cells, fast and slow cells, high threshold voltage cells and low threshold voltage cells, and various combinations thereof including positive and negative logic.

As an example and in accordance with various embodiments, an apparatus includes an application circuit, and a decoding circuit. The application circuit carries out a specific set of actions on an input data vector. For example, the application circuit is the actual circuitry that performs a certain task, and which can have redundant copies of logic circuits performing the same task, as described below. The application circuit includes a plurality of coded-diversification pathways provided by, for example, a first diversification logic circuit and a second diversification logic circuit. The first diversification logic circuit processes data corresponding to the input data vector and in response, generates a coded first output data vector. The second diversification logic circuit processes the data corresponding to the input data vector and in response, generates a coded second output data vector, the coded second output data vector being uniquely coded relative to the coded first output data vector. The decoding circuit, which includes a decoder configured as a function of the second diversification logic circuit, assesses the coded first output data vector relative to the coded second output data vector and, in response, generates output data indicative of a likelihood of a design weakness in the application circuit.

In various embodiments, the application circuit and the decoding circuit are implemented as parts of a common integrated circuit chip with other circuitry and in other embodiments implemented using different chips of an integrated circuit chip. Both the application circuit and the other circuitry (e.g., an application-specific circuit or other application circuits) can include field-effect circuitry manufactured using common materials and manufacturing steps.

The second diversification logic circuit is a diverse and redundant version of the first diversification logic circuit, and is not configured and arranged the same as the first diversification logic. The first and second diversification logic circuits can provide the same function with output data vectors that are uniquely coded. For example, the second diversification logic circuit includes logic that is a negative version of logic of the first diversification logic circuit. In other embodiments and/or in addition, the second diversification logic includes at least one of a complex cell, timing circuitry affecting processing timing of the coded second output data vector, a half or full adder, relatively-low threshold voltage transistors and/or relatively-high threshold voltage transistors, among other variations. As a specific example, the first diversification logic circuit generates the coded first output data vector at a time defined as a function of the first diversification logic circuit, and the second diversification logic circuit generates the coded second output data vector at a time defined as a function of the second diversification logic circuit. The decoding circuit, in such an example, can process the coded first output data vector and the coded second output data vector by aligning the times defined as the functions of the respective first and second diversification logic circuits.

In a number of specific embodiments, the apparatus includes more than two diversification logic circuits with diverse redundancy used to mitigate system design weaknesses. The apparatus includes a third diversification logic circuit having a mixture or different combination of logic than the first and second diversification logic circuits. As a specific example, the second diversification logic circuit includes negative logic, the first diversification logic circuit includes positive logic, and the third diversification logic circuit includes a mixture of negative logic and positive logic. The third diversification logic processes the received data and in response, generates a coded third output data vector, the coded third output data vector being uniquely coded relative to the coded first output data vector and the coded second output data vector. Each of the diversification logic circuits can be located at different places with respect to one another, such that design weakness can be further diversified by the different locations.

The apparatus can further include a comparison circuit. The comparison circuit can be part of the decoding circuit or separate therefrom. The comparison circuit compares the coded first and second output data vectors, and optionally, the coded third output data vector, and generates the output data indicative of the likelihood of the design weakness based on the comparison. The comparison circuit can, for example, generate the output data based on a two-of-three vote between the output data vectors as decoded.

In another specific example embodiment, a method includes carrying out a specific set of actions on an input data vector via an application circuit, and providing the input data vector through a plurality of coded-diversification pathways. For example, the method includes processing received data corresponding to the input data vector through a first coded-diversification pathway provided by a first diversification logic circuit and, in response, generating a coded first output data vector, and processing the received data through a second coded-diversification pathway provided by a second diversification logic circuit and in response, generating a coded second output data vector. The method further includes assessing the coded first output data vector relative to the coded second output data vector, and in response, generating output data indicative of a likelihood of design weakness in the application circuit.

As previously described, the second diversification logic circuit is a redundant and diversified version of the first diversification logic circuit. For example, generating the coded second output data vector can include generating the coded second output data vector that is a negative version of the coded first output data vector, although embodiments are not so limited. Further, the data can be processed through additional coded-diversification data pathways. In specific embodiments, the method further includes processing the received data through a third coded diversification pathway provided by a third diversification logic circuit and in response, generating a coded third output data vector, the coded third output data vector being uniquely coded relative to the coded first and coded second output data vectors. The coded first output data vector can be assessed relative to the coded second output data vector and the coded third output data vector, and in response, the output data indicative of the likelihood of design weakness in the application circuit is generated.

In a number of embodiments, the method further includes (and/or the above-describe apparatus further performs) performing an additional action in response to the assessment of the coded first output data vector relative to the coded second output data vector indicating a likelihood of the weakness. The additional action includes at least one of: performing a self-test or a structural test by an external entity, such as a built-in self-test, disabling one of the first and second diversification logic circuits, rebooting the system, issuing a warning message, and/or shutting the system down, among other actions.

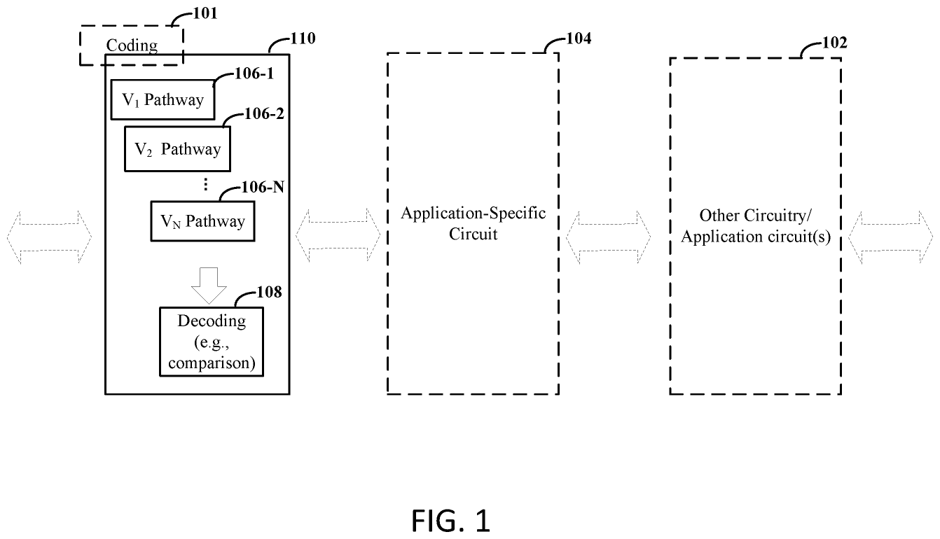

FIG. 1 illustrates an example of an apparatus having diversification logic circuits, in accordance with various embodiments. As previously described, various apparatuses can includes an application circuit 110 having a plurality of coded-diversification pathways 106-1, 106-2 . . . 106-N, each used to provide a particular function in a different way. The coded-diversification pathways 106-1, 106-2 . . . 106-N are provided by different diversification logic circuits that generate coded output data vectors that are uniquely coded with respect to one another. The diversification logic circuits can be said to be redundant and diversified versions of one another as they provide the same function via unique coding resulting from the different coded-diversification pathways 106-1, 106-2 . . . 106-N.

The application circuit 110 carries out a specific set of actions on an input data vector. In specific embodiments, the apparatus can include additional circuitry that is in communication with the application circuitry 110, such as an application-specific circuit 104 and/or other application circuits 102. In some specific embodiments, the application-specific circuit 104 can provide data corresponding to the input data vector to the application circuit 110 having the plurality of coded-diversification pathways 106-1, 106-2 . . . 106-N. The application-specific circuit 104 and the application circuit 110 and/or circuits can be implemented as part of a common integrated chip with each including field-effect circuitry or using different chips of an IC having field effect circuitry. The field-effect circuitry can be manufactured using common materials and manufacturing steps, although embodiments are not so limited to field-effect circuitry and can include other circuitry, such as bipolar circuitry for example. As illustrated, the apparatus can include additional application circuits 102 which can have different coded logic pathways.

The particular application circuit 110 having the plurality of coded-diversification pathways 106-1, 106-2 . . . 106-N can include at least a first diversification logic circuit and a second diversification logic circuit. The first diversification logic circuit can receive the data corresponding to the input data vector (such as, optionally, from additional coding circuitry 101) and process the received data through the first coded-diversification pathway 106-1 of the first diversification logic circuit by generating a coded first output data vector. In some specific embodiments, the coded first output data vector is generated at a time defined as a function of the first diversification logic circuit. The second diversification logic circuit can receive the data corresponding to the input data vector and process the received data through the second coded-diversification pathway 106-2 of the second diversification logic circuit by generating a coded second output data vector. The coded second output data vector is uniquely coded relative to the coded first output data vector, and in some specific embodiments, the coded second output data vector is generated at a time defined as a function of the second diversification logic circuit.

The second diversification logic circuit is a redundant and diversified version of the first diversification logic circuit that provides the same respective function in a different way. For example, the second diversification logic circuit that provides the second coded-diversification pathway 106-2 can be configured differently than the first diversification logic circuit that provides the first coded-diversification pathway 106-1. Providing redundant and diversified pathways can be beneficial for various applications to allow for resolution of design weakness that may be difficult to predict in advance. By having diversified pathways, different design weakness can be accounted for and having redundant pathways providing the same function can allow for overcoming the weakness by disabling one redundant pathways in response to a failure, among other actions such as shutting-down or rebooting the system.

In various more specific embodiments, the apparatus includes a second implementation of a logic circuit, which is on the one hand differing on logic level, such as the logic gate level (so that possible weaknesses are not copied), but on the other hand similar to the original logic circuit (so that additional development and verification effort is avoided). The diversification can be provided by implementing one diversification logic circuit having positive logic, and the other having negative logic. With positive logic, high voltage represents logic 1 and low voltage represents logic 0. For negative logic, high voltage represents logic 0 and low voltage represents logic 1. Both negative and positive logic uses logic gates of the same library, such as the negative logic includes AND gates replaced by OR gates. However, embodiments are not so limited and can include more than two diversification logic circuits and/or the diversification can be implemented in addition to or alternatively to the negative logic, in a number of ways. Other diversification implementations can include complex cells, adders to multiplexers, timing circuitry, half or full adder and timing circuitry, use of relatively-low threshold voltage transistors and relatively-high threshold voltage transistors, etc.

In various specific embodiments, the diversification can be implemented via positive logic, negative logic, and/or various mixtures thereof. For example, the first diversification logic circuit can include all positive logic and the second diversification logic circuit can include all negative logic. In such embodiments, the first diversification logic circuit can be referred to as a positive logic module and the second diversification logic circuit can be referred to as a negative logic module, although embodiments are not so limited and the second diversification logic circuit can include various combinations of positive logic and negative logic. To convert a positive logic module to a negative logic module or individual logic thereof, the following can be performed on the gate level: invert all module inputs; replace all OR gates by AND gates; replace all AND gates by OR gates; replace all NOR gates by NAND gates; replace all NAND gates by NOR gates; replace all multiplexers by multiplexers with low-active select input (or: keep the multiplexer but swap its inputs); replace all flip-flops by flip-flops with low-active set, reset, clock inputs; and invert all module outputs.

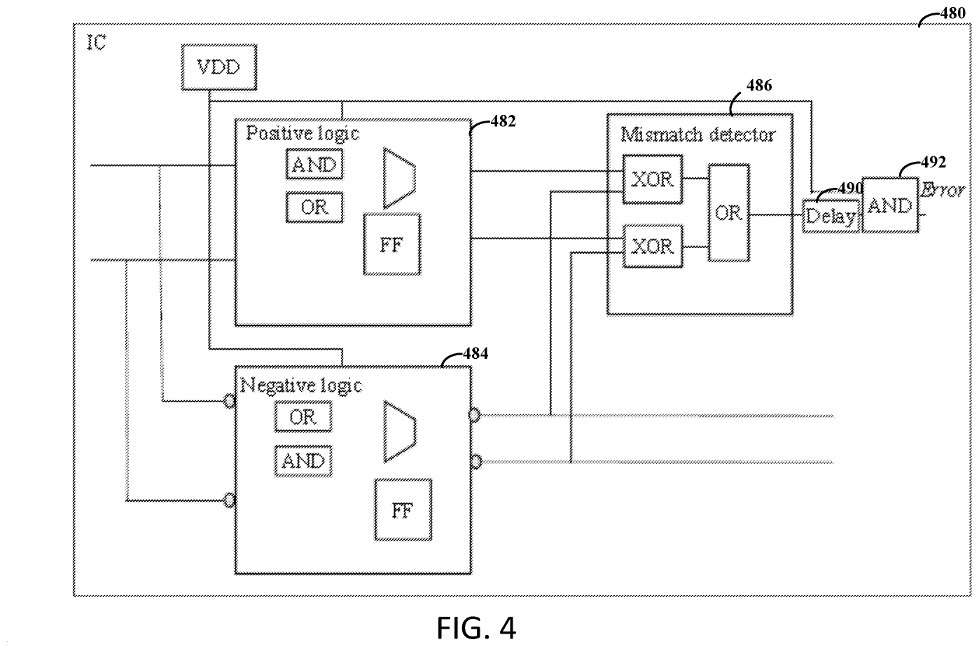

In some embodiments, replacing positive logic with negative logic in one of the diversification logic circuits can cause issues when the apparatus is being powered down as both the positive and negative logic (e.g., diversification logic circuits) may output a zero. For the negative logic, this output of zero may result in a spike that is harmful for the logic behaviors of subsequent logic circuitry. For example, the application circuit 110 comprising the first and second diversification logic circuits respectively having positive and negative logic can suddenly shut-down, such as in the course of energy saving carried out by external ICs or an unintended brown-out event. The sudden shut-down causes both the first and second diversification logic circuits to output a zero, and which can cause a spike in the signal provided to other circuitry. The potential risk of spikes due to shutting down the application circuit can be counter-acted by gating a delayed version of the error signal output by the decoding circuit (comparison circuit) with the power signal, as further illustrated by FIG. 4. That way, even in case such spikes occur, they do not lead to an error.

In other embodiments and/or in addition to the mixture of positive logic and negative logic, diversification can alternatively and/or in addition be provided from other physical points of view. For example, modification can include mixing cells with different threshold voltages transistors or cells, sometimes herein referred to as High Threshold Voltage (HVT), Low Threshold Voltage (LVT), and/or Standard Threshold Voltage (SVT) cells, while keeping the total delay time near constant; replacing complex cells that include several single logic gates (e.g. a full adder core library cell) by these single cells, and vice versa; and/or replacing single cells by another combination of single cells that perform a similar logic function, e.g., replacing a multiplexer by gates performing the multiplexing operation. Single cells are sometimes interchangeably referred to as simple cells herein. More specifically, the second diversification logic circuit can include complex cells and timing circuitry affecting the processing timing of the coded second output data vector as compared to simple cells in the first diversification logic circuit. In another example, the second diversification logic circuit can include multiplexers and/or combinatorial cells with three or more inputs as compared to adders of the first diversification logic circuit. As another example, the second diversification logic circuit can include a half of fuller adder and timing circuitry affecting the timing of the coded second output data vector as compared to the coded first output data vector. As an additional example, the second diversification logic circuit can include relatively-low threshold voltage transistors and relatively-high threshold voltage transistors, such as a different mixture of relatively-low threshold voltage transistors and relatively-high threshold voltage transistors as compared to the first diversification logic circuit. The SVT/HVT cells can have some timing delay with the SVT cells being faster but consuming more energy. A mixture of SVT and HVT cells can be different between the two diversification logic circuits to have each of the pathways 106-1, 106-2 a threshold speed and consuming below a threshold energy. The mixture of SVT/HVT cells can be changed between redundant pathways while still achieving one or more timing constraints for the redundant pathways. In many embodiments, there can be more than one timing constraint with at least one hold timing constraint and one setup timing constraint (e.g., one minimum transfer time and one maximum transfer time). Other modifications can include the second diversification logic circuit including one of analog circuits and digital circuits and the first diversification logic circuit including the other of the analog circuit and digital circuits, e.g., the second diversification logic circuit includes analog circuits and the first diversification logic circuit include digital circuits.

These modifications can be performed by a simple script that is adapted for the respective core library. In cases where a direct replacement for a certain logic gate cell is not available in the core library, a combination of two core library cells can be used. A simple backend run is performed to make the new netlist timing clean. In specific embodiments, a verification run is performed to verify that the two or more modules (e.g., diversification logic circuits) perform the same functionality.

As illustrated in various embodiments, more than two coded-diversification pathways can be provided. For example, a third (or more) diversification logic circuit can receive the data corresponding to the input data vector and process the received data through the third coded-diversification pathway 106-N of the third diversification logic circuit by generating a coded third output data vector. The coded third output data vector is uniquely coded relative to the coded first output data vector and the coded second output data vector, and in some specific embodiments, the coded third output data vector is generated at a time defined as a function of the third diversification logic circuit. Similarly to that described above, the third diversification logic circuit is a redundant and diversified version of the first and second diversification logic circuits that provides the same respective function in a different way. In specific embodiments, the third diversification logic circuit can include a mixture of logic of the first and second diversification logic circuits. For example, the third diversification logic circuit can include a mixture of negative logic and positive logic. As another example, the third diversification logic circuit can include a different mixture of SVT/HVT cells than the first and second diversification logic circuits. Other variations include different combinations of complex and simple cells, different timing circuitry, analog and digital, etc.

The apparatus further includes a decoding circuit 108 that includes a decoder configured as a function of at least the second diversification logic circuit. The decoding circuit 108 can assess the coded first output data vector relative to the coded second output data vector (and, optionally, one or more data vectors), and in response, generates output data indicative of a likelihood of a design weakness in the application circuit 110. The output data indicative of a likelihood of design weakness includes, is based on, and/or is response to one or more of the coded output data vectors being different from what is expected (e.g., is wrong) and which is due to the design weakness. That is, the design weakness causes the output data vector to be wrong and the output data is indicative of the output data vector being wrong, such as an error signal. The decoding circuit 108 can process the coded first output data vector and the coded second output data vector by aligning the times as defined as a function of the respective first and second diversification logic circuits. In other embodiments and/or in addition, the decoding circuit 108 can invert one or more bits of the coded second output data vector. For example, the second diversification logic circuit includes an OR gate (which is replacing an AND gate of the first diversification logic circuit), the coded second output data vector or a portion thereof can be inverted. By contrast, if the second diversification logic circuit includes a NOR gate (which is replacing an NAND gate), the coded second output data vector or portion thereof can already be inverted.

The application circuit 110 can further include a comparison circuit, which may be part of or separate from the decoding circuit 108. The comparison circuit can compare the generated first and second (as coded or decoded output data vectors and/or compare the first, second, third (and optionally more) output data vectors and therefrom, generate the output data indicative of the likelihood of the design weakness. In various specific embodiments, the comparison circuit is a voter block that compares the first, second, third (and optionally more) output data vectors and outputs the data based on a two-of-three (or other) vote between the output data vectors.

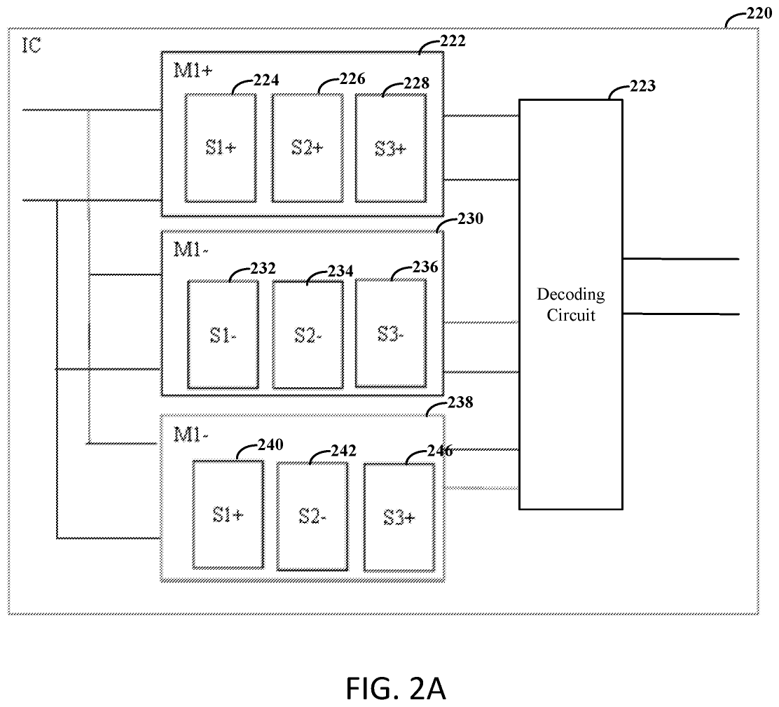

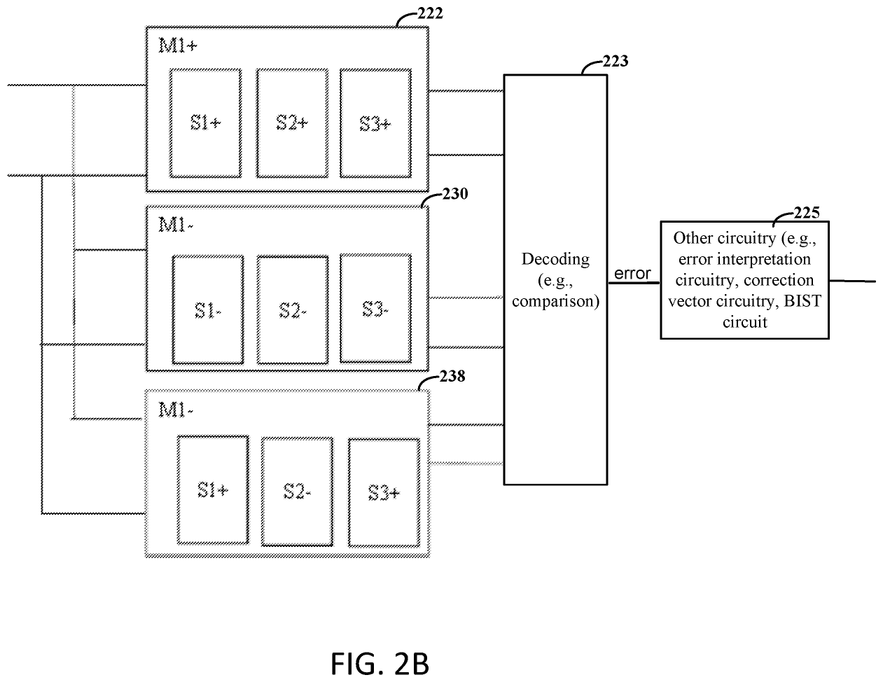

FIGS. 2A-2B illustrate specific examples of apparatuses having diversification logic circuits, in accordance with various embodiments. As previously described, the diversification logic circuits 222, 230, 238 are redundant and diversified versions of one another that provide the same function in different manners, such as different combinations of logic, thereby providing different coded-diversification pathways. In specific embodiments, the diversification logic circuits 222, 230, 238 include different mixtures of positive and negative logic from one another. For example, a first diversification logic circuit includes positive logic, a second diversification logic include negative logic, and a third diversification logic includes a mixture of positive and negative logic. Although embodiments are not so limited and can include a variety of different diversification, such as different mixtures of positive and negative logic, complex cells, mixtures of simple and complex cells, timing circuitry, mixtures of relatively-low threshold voltage transistors and relatively-high threshold voltage transistors, etc., as previously described.

As illustrated, in various specific embodiments, an application circuit 220 can include more than two redundant modules, e.g., the diversification logic circuits, such as three redundant modules which is also referred to herein as “triple mode redundancy” as compared to two redundant modules or “dual mode redundancy.” As a specific example, the first diversification logic circuit 222 includes positive logic 224, 226, 228, the second diversification logic circuit 230 include negative logic 232, 234, 236 and the third diversification logic circuit 238 includes a mixture of positive and negative logic 240, 242, 246. By using positive and negative logic in the diversification logic circuits (e.g., submodules of the replicated block), the application circuit 220 includes three different versions and thus realizes triple mode redundancy.

Also in this embodiment, the logic gates, timing paths and logic levels differ from one diversification logic circuit to the other, such that possible weaknesses (e.g., premature aging, timing issues) in one diversification logic circuit is likely not be present in the other diversification logic circuits. To save backend work, each logic (e.g., submodule) can be layout once, and then inserted into the respective main diversification logic circuit.

In accordance with various embodiments, the illustrated diversification logic circuits can be more diversified than illustrated, as previously discussed. For example, the logic 224, 226, 228 in the first diversification logic circuit 222, e.g. submodule M1+S1+, can be realized in a different way than logic 240, 242, 246 in the third diversification logic circuit 238, e.g., submodule M1−S1+, hence providing three or more instead of two different implementations of logic, e.g., the submodule S1+/S1−, with the advantage of further resistance against common mode failures, e.g., due to higher, unintended aging sensitivity of one way of implementation.

More specifically and as illustrated specifically by FIG. 2A, the application circuit 220 can include a plurality of coded-diversification pathways provided by different diversification logic circuits 222, 230, 238. Each of the different diversification logic circuits 222, 230, 238 can include different logic combinations that provide the same output via uniquely coded output data vectors. Although the specific embodiments illustrated by FIG. 2A (and FIG. 2B) illustrates positive logic 224, 226, 228, negative logic 232, 234, 236, and mixture of positive and negative logic 240, 242, 246, embodiments are not so limited. For example, the different diversification logic circuits 222, 230, 238 can each include different mixtures of positive and negative logic, different mixtures of simple and complex cells, different mixtures of high speed and low speed (or standard speed) cells, and other variations including various combinations thereof.

The output data vectors from the first, second and third diversification logic circuits 222, 230, 238 are provided to the decoding circuit 223. The decoding circuit 223 can include a decoder that is configured as a function (of the coding) of at least one of the diversification logic circuits 222, 230, 238, such as based on times defined by the respective diversification logic circuits 222, 230, 238 or output values (e.g., inverting). The decoding circuit 223 processes the coded first, second and third output data vectors by assessing the data vectors. The assessment can include decoding (e.g., inverting or aligning times as a function of the diversification logic circuits 222, 230, 238) and/or otherwise comparing the output data vectors. For example, the decoding circuit 223 can compare decoded versions of the output data vectors to identify whether the coded data vectors match or are mismatched. Based on the comparison, the decoding circuit 223 generates output data indicative of a likelihood of a design weakness in the application circuit, such as an error signal that is indicative of the coded output data vectors matching or not. In response to a mismatch, in specific embodiments, and as further illustrated herein, the apparatus can check the diversification logic circuits 222, 230, 238 for a design weakness, such a performing a built-in self-test or other action.

FIG. 2B illustrates an example of an application circuit, in accordance with the present disclosure. The application circuit of FIG. 2B can include the application circuit 220 illustrated by FIG. 2A and/or the components thereof, such as the diversification logic circuits 222, 230, 238 and decoding circuit 223. In various embodiments, the application circuit and/or another component of the apparatus further includes other circuitry 225 that performs one or more functions based on the error signal output by the decoding circuit 223. The additional action can include performing a built-in self-test, disabling one of the first, second, or third diversification logic circuits 222, 230, 238, rebooting the system, issuing a warning that the application circuit may be unreliable, and/or shutting the system down. As illustrated, the other circuitry 225 can include one or more of an error interpretation circuitry, correction circuitry, and built-in self-test circuitry. For example (such as for dual mode redundancy), a mismatch can result in an IC reset, a complete system reboot, a built-in self-test on both modules to determine the faulty one, and/or switch off of the system, etc.

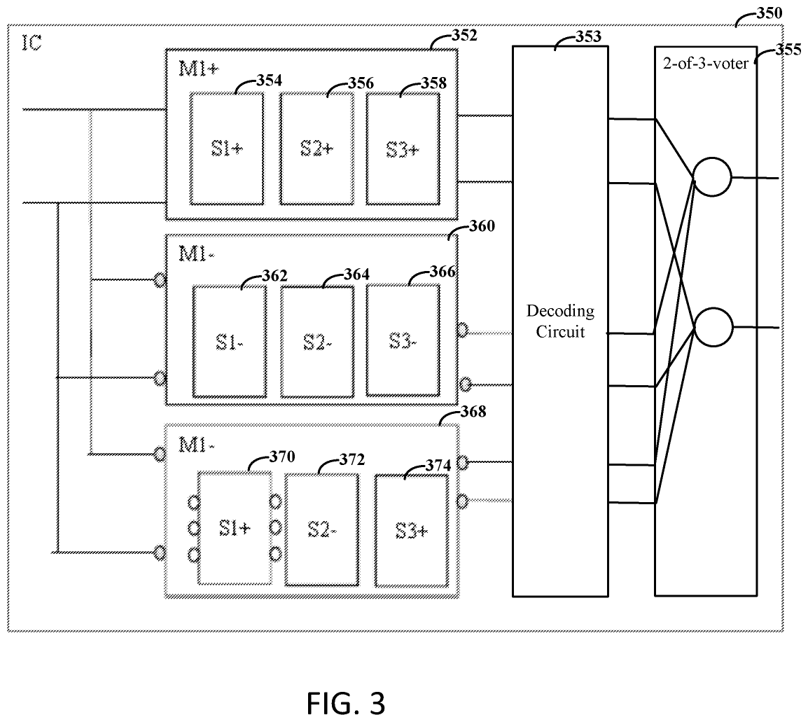

FIG. 3 illustrates an example apparatus, in accordance with various embodiments. As illustrated, an application circuit 350 provides a plurality of coded-diversification pathways via a plurality of diversification logic circuits 352, 360, 368. In the specific embodiments, the application circuit 350 includes three diversification logic circuits 352, 360, 368, however, embodiments are not so limited. In the specific example of FIG. 3, the first diversification logic circuit 352 includes positive logic 354, 356, 358, the second diversification logic circuit 360 includes negative logic 362, 364, 366, and the third diversification logic circuit 368 includes a mixture of positive logic 370, 374 and negative logic 372. However, embodiments are not so limited and the diversification logic circuits 352, 360, 368 can include additional or alternative variations in logic than positive and negative logic, such as different combinations of complex and simple cells, among other variations as previously described.

The diversification logic circuits 352, 360, 368 can process data corresponding to an input data vector. The first diversification logic circuit 352 processes the data through a first coded diversification pathway via logic 354, 356, 358, and provides a coded first output data vector. The second diversification logic circuit 360 processes the data through a second coded diversification pathway via logic 362, 364, 366, and provides a coded second output data vector. The third diversification logic circuit 368 processes the data through a third coded diversification pathway via logic 370, 372, 374, and provides a coded third output data vector. The first, second, and third output data vectors are uniquely coded relative to one another.

The application circuit 350 further includes a decoding circuit 353 and comparison circuit, e.g., the two-of-three voter 355. The decoding circuit 353 decodes each of the coded output data vectors, such as based on a function of the diversification logic circuits 352, 360, 368. For example, the decoding circuit 353 can invert bits from negative logic and/or align times of the data vectors as a function of the respective diversification logic circuits 352, 360, 368. In various embodiments, data bits from the negative logic is inverted by the diversification logic circuits 352, 360, 368 themselves, such as with NOR gates as previously described.

The comparison circuit accesses the decoded output data vectors and, in response, generates output data indicative of a likelihood of a design weakness in the apparatus. In various embodiments, the output data includes an error signal that is indicative of match or mismatch between the output data vectors. In response to a mismatch, one or more actions can be triggered, as previously described. In specific embodiments, the comparison circuit includes a two-of-three voter 355. The two-of-three voter 355 outputs data based on a two out of three vote between the decoded output data vectors. The data output by the two-of-three voter 355 can ignore an output data vector from a defective diversification logic circuit. For triple mode redundancy, a mismatch can result in continuing the normal functionality on short term. As the required safety level may not be kept anymore, on the long term, an action can be performed, such as an IC reset, a complete system reboot, a built-in self-test on the modules to determine the faulty one, or a switch off, etc.

Various application circuits, as described above, can be used in Near-Threshold-Computing (NTC). NTC uses low supply voltages for maximum energy saving. This energy advantage comes with the drawback of error rates that are higher by several orders of magnitude, so that with even non-safety sensitive applications, dual or triple mode redundancy can be advantageous. The energy saving of a factor of around ten compared to nominal supply voltage, leaves sufficient enough margin for tripling sensitive modules and still having an overall energy saving, which is within an acceptable error rate. In NTC, the error rate is not only high, but also strongly depending on temperature, supply voltage, process corner and the type of logic gate. This makes diverse redundancy interesting for NTC. Another reason diverse redundancy is beneficial for NTC is due to the fact that the error rate is determined by noise margin, noise caused, e.g., by electromagnetic interference might affect two or three identical replicas in the same way (“Single Point of Failure”) and thus make redundancy using identical replicas ineffective, whereas diverse redundancy may allow for much better error correction.

FIG. 4 illustrates an example IC, in accordance with various embodiments. The IC 480 includes an application circuit having dual mode redundancy, however embodiments are not so limited and can include triple redundancy or more. The IC 480 includes circuitry (e.g., 490, 492) used to account for non-symmetry of the negative logic 484 in a power-off state of the IC 480.

The IC 480 illustrated by FIG. 4 can include one or more of the previous illustrated circuits, such as illustrated by FIG. 1. For example, the IC 480 includes an application circuit that has a plurality of coded-diversification pathways provided by first and second diversification logic circuits. The specific first and second diversification logic circuits provide the same function respectively using positive logic 482 and negative logic 484 that uniquely codes data and provides different coded output data vectors. The IC 480 can additionally include a coding circuit and/or a decoding circuit. The coding circuit can code the input data vector, which is provided through the coded-diversification pathways. The decoding circuit can decode the coded output data vectors and assess the decoded output data vectors. The decoding circuit includes a decoder configured as a function of at least one of the first and second diversification logic circuits, which can decode the output data vectors such as by inverting the data vector output by the negative logic 484. For example, the signal inversions (e.g., coding) at the input and signal inversions (e.g., decoding) at the output are denoted by the circles on the inputs and outputs of the negative logic 484. In other embodiments and/or in addition, the decoder can perform other actions, such as aligning the times as a function of the first and second diversification logic circuits. The decoding circuit can additionally include a comparison circuit, illustrated by the mismatch detector circuit 486. The comparison circuit can compare the decoded output data vectors and output data indicative of a likelihood of a design weakness in the application circuit, e.g., the IC 480.

As previously described, in various embodiments, various IC can have particular behavior when powered-down. In many ICs, power saving measures are extensively applied, including dynamically powering up and down dedicated blocks. With negative logic, the negative logic may not be completely symmetric to positive logic. For example, a powered down block can be powered down with respect to its positive supply, hence the outputs are all on “0” value—similar to positive logic, and not opposite to it as it should be for symmetry reasons. More specifically, the diversification logic circuits having negative logic can invert the output data vectors to decode the vectors. After inverting, the signal that is 0 for positive logic is also 0 for the negative logic. During shut-down of the IC 480, this may happen, however, due to signal racing the input of the inverter goes to 0, and the output of the inverter goes to 1, before the logic isolation can gate this signal. Hence, the signal after the isolation cell has a spike and such a spike can be harmful for the logic behavior of the subsequent circuitry. This situation can occur if IC 480 is suddenly shut down, e.g., in the course of energy saving carried out by external ICs, or at an unintended brown-out event. The other signal may start isolating the subsequent circuitry before power down, but in many embodiments, this cannot be relied on. Various embodiments, such as that illustrated by FIG. 4, can include circuitry used to resolve the lack of symmetry during power-down for diversification logic circuits having negative logic. Simply replacing positive logic by negative logic, taking into account all necessary inversions, may result in both positive and negative logic modules outputting a 0 when being powered down.

As illustrated, the potential spikes caused by the negative logic 484 are mitigated or removed by counter acting the spikes using a delay circuit 490 and a logic circuit (AND 492) that gates a delayed version of error signal, as output by the comparison circuit (e.g., mismatch detector circuit 486) with the power signal. This same circuitry (e.g., 490, 492) can be used in triple mode redundancy embodiments, such as illustrated by FIGS. 2A-2B in accordance with various embodiments.

Terms to exemplify orientation, such as upper/lower, left/right, top/bottom and above/below, may be used herein to refer to relative positions of elements as shown in the figures. It should be understood that the terminology is used for notational convenience only and that in actual use the disclosed structures may be oriented different from the orientation shown in the figures. Thus, the terms should not be construed in a limiting manner.

The skilled artisan would recognize that various terminology as used in the Specification (including claims) connote a plain meaning in the art unless otherwise indicated. As examples, the Specification describes and/or illustrates aspects useful for implementing the claimed disclosure by way of various circuits or circuitry which may be illustrated as or using terms such as blocks, modules, submodules device, system, unit, controller, and/or other circuit-type depictions (e.g., reference numerals 104 and 222 of FIGS. 1 and 2A depict a block/module as described herein). Such circuits or circuitry are used together with other elements to exemplify how certain embodiments may be carried out in the form or structures, steps, functions, operations, activities, etc. For example, in certain of the above-discussed embodiments, one or more modules are discrete logic circuits or programmable logic circuits configured and arranged for implementing these operations/activities, as may be carried out in the approaches shown in FIGS. 2A through 4. In certain embodiments, such a programmable circuit is one or more computer circuits, including memory circuitry for storing and accessing a program to be executed as a set (or sets) of instructions (and/or to be used as configuration data to define how the programmable circuit is to perform), and an algorithm or process as described herein is used by the programmable circuit to perform the related steps, functions, operations, activities, etc. Depending on the application, the instructions (and/or configuration data) can be configured for implementation in logic circuitry, with the instructions (whether characterized in the form of object code, firmware or software) stored in and accessible from a memory (circuit).

Based upon the above discussion and illustrations, those skilled in the art will readily recognize that various modifications and changes may be made to the various embodiments without strictly following the exemplary embodiments and applications illustrated and described herein. For example, methods as exemplified in the Figures may involve steps carried out in various orders, with one or more aspects of the embodiments herein retained, or may involve fewer or more steps. For instance, the apparatus illustrated by FIG. 2A can include the delay circuitry and logic circuit illustrated by FIG. 4. Such modifications do not depart from the true spirit and scope of various aspects of the disclosure, including aspects set forth in the claims.

What is claimed is:

1. An apparatus comprising:
an application circuit configured and arranged to carry out a specific set of actions on an input data vector, the application circuit having a plurality of coded-diversification pathways including:
a first diversification logic circuit configured and arranged to process data corresponding to the input data vector and in response, generate a coded first output data vector; and
a second diversification logic circuit configured and arranged to process data corresponding to the input data vector and in response, generate a coded second output data vector, the coded second output data vector being uniquely coded relative to the coded first output data vector; and
a decoding circuit including a decoder configured as a function of the second diversification logic circuit, the decoding circuit configured and arranged to assess the coded first output data vector relative to the coded second output data vector and, in response, generate output data indicative of a likelihood of a design weakness in the application circuit.

2. The apparatus of claim 1, wherein the application circuit and the decoding circuit are each implemented as parts of a common integrated circuit chip and the application circuit includes field-effect circuitry steps.

3. The apparatus of claim 1, further include other circuitry in communication with the application circuit, wherein the application circuit and the other circuitry are respectively implemented using different chips of an integrated circuit having field-effect circuitry manufactured using common materials and manufacturing steps.

4. The apparatus of claim 1, wherein the second diversification logic circuit is not configured and arranged the same as in the first diversification logic circuit and includes at least one of: a complex cell, and timing circuitry affecting processing timing of the coded second output data vector.

5. The apparatus of claim 1, wherein the second diversification logic circuit is not configured and arranged the same as in the first diversification logic circuit and includes at least one of: a half or full adder and timing circuitry affecting processing timing of the coded second output data vector.

6. The apparatus of claim 1, wherein the decoding circuit is further configured to process the coded first output data vector and the coded second output data vector by aligning the times defined as a function of the respective first and second diversification logic circuits.

7. The apparatus of claim 1, wherein the second diversification logic circuit is not configured and arranged the same as in the first diversification logic circuit and is implemented using relatively-low threshold voltage transistors and relatively-high threshold voltage transistors.

8. The apparatus of claim 1, wherein the second diversification logic circuit is a diverse redundant version of the first diversification logic circuit.

9. The apparatus of claim 1, wherein the second diversification logic circuit includes logic that is a negative version of logic of the first diversification logic circuit.

10. The apparatus of claim 1, wherein:
first diversification logic circuit is configured and arranged to generate the coded first output data vector at a time defined as a function of the first diversification logic circuit, and
the second diversification logic circuit configured and arranged to generate the coded second output data vector at a time defined as a function of the second diversification logic circuit.

11. The apparatus of claim 1, wherein the second diversification logic circuit includes logic that is negative logic as compared to logic the first diversification logic circuit and the apparatus further includes:
a third diversification logic circuit including logic that a mixture of the negative logic and positive logic.

12. The apparatus of claim 1, further including a third diversification logic configured and arranged to process the data and in response, generate a coded third output data vector, the coded third output data vector being uniquely coded relative to the coded first output data vector and the coded second output data vector.

13. The apparatus of claim 1, further including a comparison circuit configured and arranged to compare the generated coded first and second output data vectors and to generate the output data indicative of the likelihood of the design weakness based on the comparison.

14. The apparatus of claim 13, wherein the comparison circuit is configured and arranged to output data based on a two out of three vote between the coded first, second, and third output data vectors.

15. A method comprising:
carrying out a specific set of actions on an input data vector via an application circuit;
providing the input data vector through a plurality of coded-diversification pathways including:
processing received data corresponding to the input data vector through a first coded-diversification pathway provided by a first diversification logic circuit and, in response, generating a coded first output data vector;
processing the received data through a second coded-diversification pathway provided by a second diversification logic circuit and in response, generating a coded second output data vector, the coded second output data vector being uniquely coded relative to the coded first output data vector; and
assessing the coded first output data vector relative to the coded second output data vector, and in response, generating output data indicative of a likelihood of design weakness in the application circuit.

16. The method of claim 15, wherein the second diversification logic circuit is a redundant and diversified version of the first diversification logic circuit and generating the coded second output data vector includes generating the coded second output data vector that is negative version of the coded first output data vector.

17. The method of claim 15, further including performing an additional action in response to the assessment of the coded first output data vector relative to the coded second output data vector indicating a likelihood of the design weakness.

18. The method of claim 17, wherein the additional action includes at least one of: performing a built-in self-test, disabling one of the first and second diversification logic circuits, rebooting a system that includes the application circuit, issuing a warning message, and shutting the system down.

19. The method of claim 15, further including processing the data through a third coded diversification pathway provided by a third diversification logic circuit and in response, generating a coded third output data vector, the coded third output data vector being uniquely coded relative to the coded first and coded second output data vectors.

20. The method of claim 19, further including assessing the coded first output data vector relative to the coded second output data vector and the coded third output data vector, and in response, generating output data indicative of the likelihood of design weakness in the application circuit.
